(19) United States
(12) Patent Application Publication
(10) Pub. No.: US 2010/0215881 A1
(43) Pub. Date: Aug. 26, 2010

(54) DOUBLE-FACED PRESSURE-SENSITIVE ADHESIVE SHEET USED FOR ELECTRONIC COMPONENTS AND PRODUCING METHOD THEREOF

(75) Inventors: Sou Miyata, Tokyo (JP); Shiori Beppu, Tokyo (JP); Takuo Nishida, Tokyo (JP); Toshio Sugizaki, Tokyo (JP)

Correspondence Address: BRINKS HOFER GILSON & LIONE, P.O. BOX 10395, CHICAGO, IL, 60610, US

(73) Assignee: Lintec Corporation, Itabashi-ku (JP)

(21) Appl. No.: 12/682,406

(22) PCT Filed: Sep. 25, 2008
(86) PCT No.: PCT/JP2008/067332

§ 371 Date: Apr. 9, 2010

(30) Foreign Application Priority Data
Oct. 11, 2007 (JP) 2007-265908

(51) Int. Cl. B32B 33/00; B32B 37/00; B32B 9/00

(52) U.S. Cl. 428/41.3; 156/60

(57) ABSTRACT

A double-faced pressure-sensitive adhesive sheet used for electronic components is provided. The double-faced pressure-sensitive adhesive sheet comprises a pressure-sensitive adhesive layer; a first release sheet including at least a first release agent layer attached to one surface of the pressure-sensitive adhesive layer; and a second release sheet including at least a second release agent layer attached to the other surface of the pressure-sensitive adhesive layer. The first release agent layer is mainly constituted of an olefin-based resin and the second release agent layer is mainly constituted of a diene-based polymer material. When an peeling force of the first release sheet with respect to the pressure-sensitive adhesive layer is defined as “X” [mN/20 mm] and an peeling force of the second release sheet with respect to the pressure-sensitive adhesive layer is defined as “Y” [mN/20 mm], the following relation is satisfied: Y−X≧50. The pressure-sensitive adhesive layer, the first release agent layer and the second release layer contain substantially no silicone compound and substantially no halogen compound.

### TECHNICAL FIELD

The present invention relates to a double-faced pressure-sensitive adhesive sheet used for electronic components and a producing method thereof.

### RELATED ART

Electronic components such as relays, various switches, connectors, motors, and hard disk drives are widely used in various products.

In these electronic components, a double-faced pressure-sensitive adhesive sheet is used for various purposes such as temporal fastening of parts during assembly, fixing of parts and indication of contents of the parts.

Such a double-faced pressure-sensitive adhesive sheet generally includes a pressure-sensitive adhesive layer and release sheets, and it is being kept in a state that the release sheets adhere to both surfaces of the pressure-sensitive adhesive layer until it is attached to an electric component for use.

On a surface of each of the release sheets (i.e., on the surface to be attached to the pressure-sensitive adhesive layer), a release agent layer is provided for improving releasability. Conventionally, a silicone resin has been used as a constituent material of the release agent layer.

However, it is known that when such a release sheet is attached to a pressure-sensitive adhesive sheet, a silicone compound such as a low-molecular weight silicone resin, siloxane, a silicone oil, or the like contained in the release sheet is transferred to the pressure-sensitive adhesive layer of the pressure-sensitive adhesive sheet. Therefore, in a case where the pressure-sensitive adhesive sheet, to which such a release sheet has adhered, is attached to an electric component, the silicone compound transferred to the pressure-sensitive adhesive layer gradually vaporizes. In this regard, it is known that the vaporized silicone compound is deposited on, for example, a surface of an electric contact portion of the electric component due to electric arc or the like generated near the electric contact portion so that a minute silicon oxide compound layer is formed thereon.

If such a silicon oxide compound is deposited on the surface of the electric contact portion, there is a case where electric conductivity at the electric contact portion becomes poor.

Particularly, in a case where such a pressure-sensitive adhesive sheet is attached to a hard disk drive, the silicone compound transferred to a pressure-sensitive adhesive layer gradually vaporizes and is then deposited on a magnetic head, a disk surface, or the like. Further, there is a possibility that deposition of such a minute silicon oxide compound gives rise to adverse effects on reading and writing of data from and to a disk of the hard disk drive.

In order to solve the above problems, attempts to develop a release sheet consisting of a polyolefin-based film, which is subjected to no silicone treatment, have been made (see, for example, Patent Document 1).

However, in such a pressure-sensitive adhesive sheet in which the release sheets constituted of the polyolefin-based film are attached to both surfaces of a pressure-sensitive adhesive layer, there are the following problems since the release sheets constituted of the polyolefin-based film do not have sufficient heat resistance property. When a pressure-sensitive adhesive agent is applied onto the release sheet and then the applied pressure-sensitive adhesive agent is dried under the condition of a high temperature (e.g. 110° C. or higher) to obtain a pressure-sensitive adhesive layer, loosenings or crinkles are likely to occur in the release sheet due to heat shrinkage thereof. Further, the obtained pressure-sensitive adhesive sheet is unstable in peeling force thereof, so that there is a case that a part of the pressure-sensitive adhesive layer attaches to the peeled release sheet in a rupturing state. That is, there is a problem in that cohesion failure is likely to occur.

Furthermore, there is a case that an atmosphere inside the electronic component such as a hard disk drive and the like is changed to a high temperature atmosphere during the use thereof. Under the high temperature atmosphere, a gas may be generated from the pressure-sensitive adhesive layer of the pressure-sensitive adhesive sheet which has been attached to any parts of the electronic component. In such a case, the gas is likely to cause undesirable phenomena such as corrosion or malfunction of the electronic component. In order to suppress the generation of such a gas, it is necessary that the pressure-sensitive adhesive layer is dried at a high temperature to thereby volatilize materials having a low boiling point such as a solvent, an unreacted monomer and the like. Accordingly, in the release sheet as disclosed in the Patent Document, there is a problem in the heat resistance property thereof as described above.

The Patent Document is JP A-11-92720 which is one example of the related arts.

### SUMMARY OF THE INVENTION

It is therefore an object of the present invention to provide a double-faced pressure-sensitive adhesive sheet used for electronic components which can sufficiently suppress adverse effects on the electronic components and the like and exhibit superior releasability of release sheets. Further, it is another object of the present invention to provide a method of producing such a double-faced pressure-sensitive adhesive sheet.

In order to achieve the above object, the present invention is directed to a double-faced pressure-sensitive adhesive sheet. The double-faced pressure-sensitive adhesive sheet comprises: a pressure-sensitive adhesive layer having one surface and the other surface; a first release sheet including at least a first release agent layer attached to the one surface of the pressure-sensitive adhesive layer; and a second release sheet including at least a second release agent layer attached to the other surface of the pressure-sensitive adhesive layer. The first release agent layer is mainly constituted of an olefin-based resin and the second release agent layer is mainly constituted of a diene-based polymer material. When an peeling force of the first release sheet with respect to the pressure-sensitive adhesive layer is defined as “X” [mN/20 mm] and an peeling force of the second release sheet with respect to the pressure-sensitive adhesive layer is defined as “Y” [mN/20 mm], the following relation is satisfied: Y−X≧50. And the pressure-sensitive adhesive layer, the first release agent layer and the second release agent layer contain substantially no silicone compound and substantially no halogen compound. According to the present invention, it is possible to provide a double-faced pressure-sensitive adhesive sheet used for electronic components which can sufficiently suppress adverse effects on the electronic components and the like and exhibit superior releasability of release sheets.

In the double-faced pressure-sensitive adhesive sheet according to the present invention, it is preferred that the olefin-based resin is constituted of polyolefin and polyolefin-based elastomer.

In the double-faced pressure-sensitive adhesive sheet according to the present invention, it is also preferred that a ratio between an amount of the polyolefin and an amount of the polyolefin-based elastomer is in the range of 9:1 to 5:5 by mass.

In the double-faced pressure-sensitive adhesive sheet according to the present invention, it is also preferred that when the pressure-sensitive adhesive layer is heated at a temperature of 120° C. for 10 minutes to generate gases, an amount of the generated gases is 1.0 μg/cm² or less in conversion of n-decane.

In order to achieve the above another object, the present invention is directed to a method of producing a double-faced pressure-sensitive adhesive sheet used for the electronic components. The method comprises: applying a material for forming the pressure-sensitive adhesive layer onto the second release agent layer of the second release sheet to form a coating film, the material containing a pressure-sensitive adhesive; drying the coating film to thereby form the pressure-sensitive adhesive layer; and attaching the first release agent layer of the first release sheet to the one surface of the formed pressure-sensitive adhesive layer.

### BRIEF DESCRIPTION OF THE DRAWINGS

FIG. 1 is a cross-sectional view showing a double-faced pressure-sensitive adhesive sheet used for electronic components according to the present invention.

FIGS. 2A to 2D are process views showing one example of a method of producing a double-faced pressure-sensitive adhesive sheet used for electronic components according to the present invention.

### DETAILED DESCRIPTION OF THE PREFERRED EMBODIMENTS

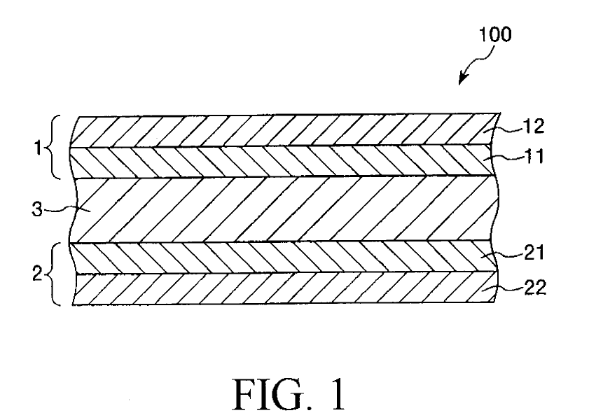

Hereinbelow, the present invention will be described in detail based on preferred embodiments thereof. FIG. 1 is a cross-sectional view showing a double-faced pressure-sensitive adhesive sheet used for electronic components according to the present invention. It is to be noted that in the following description, the upper side in FIG. 1 will be referred to as “upper” or “upper side” and the lower side in FIG. 1 will be referred to as “lower” or “lower side”.

The double-faced pressure-sensitive adhesive sheet (double-faced pressure-sensitive adhesive sheet used for the electronic components) 100 is constituted from a pressure-sensitive adhesive layer 3, a first release sheet 1 attached to one surface of the pressure-sensitive adhesive layer 3 and a second release sheet 2 attached to the other surface of the pressure-sensitive adhesive layer 3 as shown in FIG. 1. The first release sheet 1 is constituted from a first release sheet base 12 and a first release agent layer 11 as shown in FIG. 1. The second release sheet 2 is constituted from a second release sheet base 22 and a second release agent layer 21 as shown in FIG. 1.

The double-faced pressure-sensitive adhesive sheet 100 according to the present invention is attached to electronic components such as relays, various switches, connectors, motors, hard disk drives, and the like and has features as follows. The first release agent layer 11 of the first release sheet 1 is mainly constituted of an olefin-based resin. The second release agent layer 21 of the second release sheet 2 is mainly constituted of a diene-based resin. When a peeling force of the first release sheet 1 with respect to the pressure-sensitive adhesive layer 3 is defined as “X” [mN/20 mm] and a peeling force of the second release sheet 2 with respect to the pressure-sensitive adhesive layer 3 is defined as “Y” [mN/20 mm], the following relation is satisfied: Y−X≧50. Furthermore, the pressure-sensitive adhesive layer 3, the first release agent layer 11 and the second release agent layer 21 include substantially no silicone compound and substantially no halogen compound.

Due to such features, it is possible for the double-faced pressure-sensitive adhesive sheet according to the present invention to sufficiently suppress adverse effects on the electronic components as described above. Further, when the first release sheet 1 is peeled off, it is possible to prevent that the second release sheet 2 is peeled off from the pressure-sensitive adhesive layer 3 at an interface therebetween. Further, it is possible to prevent that a part of the pressure-sensitive adhesive layer 3 attaches to the peeled first release sheet 1 in a rupturing state. That is, it is possible to prevent what is called cohesion failure from occurring.

In such a double-faced pressure-sensitive adhesive sheet 100, after the first release sheet 1 is peeled off from the pressure-sensitive adhesive layer 3, the one surface of the pressure-sensitive adhesive layer 3 from which the first release sheet 1 has been peeled off is attached to an adherend. Thereafter, by peeling off the second release sheet 2 from the pressure-sensitive adhesive layer 3, it is possible to attach the adherend to other adherends.

First, a description will be made on the first release sheet 1 in detail. As shown in FIG. 1, the first release sheet 1 is constituted from the first release sheet base 12 and the first release agent layer 11.

A peeling force of the first release sheet 1 with respect to the pressure-sensitive adhesive layer 3 is lower than that of the second release sheet 2 described later with respect to the pressure-sensitive adhesive layer 3.

To be concrete, the peeling force of the first release sheet 1 with respect to the pressure-sensitive adhesive layer 3 is preferably in the range of 10 to 200 mN/20 mm, more preferably in the range of 30 to 100 mN/20 mm This makes it possible to reliably peel off the first release sheet 1 from the pressure-sensitive adhesive layer 3.

The first release sheet base 12 has a function of supporting the first release agent layer 11. It is constituted of, for example, a plastic film such as a polyester film (e.g., a polyethylene terephthalate film, a polybutylene terephthalate film, or the like), a polyolefin film (e.g., a polypropylene film, a polymethylpentene film, or the like), a polycarbonate film, or the like; a metal foil such as an aluminum foil, a stainless steel foil, or the like; paper such as glassine paper, woodfree paper, coated paper, impregnated paper, synthetic paper, or the like; or laminated paper obtained by coating such a paper base material with a thermoplastic resin such as polyethylene, or the like.

An average thickness of the first release sheet base 12 is not particularly limited to a specific value, but is preferably in the range of 5 to 300 μm, and more preferably in the range of 10 to 200 μm.

The first release agent layer 11 is constituted of a material containing substantially no silicone compound. This makes it possible to prevent the transfer of a silicone compound from the first release agent layer 11 to the pressure-sensitive adhesive layer 3 in the double-faced pressure-sensitive adhesive sheet 100. As a result, it is possible to prevent the silicone compound from being released from the pressure-sensitive adhesive layer 3 after the pressure-sensitive adhesive layer 3 is attached to an adherend. Therefore, even when the adherend is the electronic equipment such as a relay, the pressure-sensitive adhesive layer 3 is hard to give adverse effects to such an adherend.

It is to be noted that the phrase “containing substantially no silicone compound” in this specification means that an amount of the silicone compound measured by X-ray photoelectron spectroscopy (XPS) is preferably 0.5 atomic % or less, and more preferably 0.1 atomic % or less. The measurement conditions of X-ray photoelectron spectroscopy (XPS) are as follows, and the amount of the silicone compound is calculated in the following manner using measured values.

Measurement instrument: Quantera SXM manufactured by ULVAC-PHI, INC.

X-ray: A1Kα (1486.6 eV)

Takeoff angel: 45°

Elements measured: silicon (Si) and carbon (C)

The amount of the silicone compound is expressed in “atomic %” calculated by multiplying the value of Si/(Si+C) by 100.

Further, the first release agent layer 11 (and first release sheet base 12) is (are) constituted of a material containing substantially no halogen compound. Therefore, even if the first release sheet 1 is disposed of after the use thereof, a harmful halogen compound such as dioxins and the like is not generated during incineration of the first release sheet 1.

It is to be noted that the phrase “containing substantially no halogen compound” in this specification means that an amount of the halogen compound is preferably 500 μg/m² or less, and more preferably 100 μg/m² or less.

To be concrete, the first release agent layer 11 is mainly constituted of the olefin-based resin. Examples of such an olefin-based resin include an polyolefin such as polyethylene which includes low-density polyethylene (LDPE, density: 0.910 g/cm³ or more but lower than 0.930 g/vm³), middle-density polyethylene (MDPE, density: 0.930 g/cm³ or more but lower than 0.942 g/vm³) and high-density polyethylene (HDPE, density: 0.942 g/cm³ or more), polypropylene, polybutene, poly(4-methyl-1-pentene) and the like; polyolefin-based elastomer such as a copolymer (of which density is preferably in the range of 0.850 to 0.905 g/cm³) obtained by copolymerizing ethylene and α-olefin having a carbon number of 3 to 10 and the like. These resins may be used singly or in combination of two or more of them.

Among these resins described above, it is preferred that the olefin-based resin is constituted of the polyolefin and the polyolefin-based elastomer. In particular, it is more preferred that the olefin-based resin contains a copolymer obtained by the low-density polyethylene, ethylene and the α-olefin having the carbon number of 3 to 10. This makes it possible to reliably peel off the first release sheet 1 from the pressure-sensitive adhesive layer 3. In addition to that, it is possible to set an appropriate difference between the peeling force of the first release sheet 1 with respect to the pressure-sensitive adhesive layer 3 and the peeling force of the second release sheet 2 with respect to the pressure-sensitive adhesive layer 3 which will be described later.

Further, in a case where the olefin-based resin is constituted of the polyolefin and the polyolefin-based elastomer, a ratio between an amount of the polyolefin and an amount of the polyolefin-based elastomer is preferably in the range of 9:1 to 5:5, more preferably in the range of 7:3 to 5:5 by a mass ratio. This makes it possible to reliably peel off the first release sheet 1 from the pressure-sensitive adhesive layer 3. In addition to that, it is possible to reliably set an appropriate difference between the peeling force of the first release sheet 1 with respect to the pressure-sensitive adhesive layer 3 and the peeling force of the second release sheet 2 with respect to the pressure-sensitive adhesive layer 3 which will be described later.

An average thickness of the first release agent layer 11 is not particularly limited, but is preferably in the range of 3 to 30 μm, more preferably in the range of 5 to 30 μm, and even more preferably in the range of 5 to 25 μm. If the average thickness of the first release agent layer 11 is less than the above lower limit value, there is a case where releasability of the first release sheet 1 is poor when the first release sheet 1 is peeled off from the pressure-sensitive adhesive layer 3. On the other hand, if the average thickness of the first release agent layer 11 exceeds the above upper limit value, there is a case where blocking is likely to occur between the first release agent layer 11 and the back surface of the first release sheet 1 (first release sheet base 12) when the first release sheet 1 is wound up in a rolled form so that the releasability of the first release agent layer 11 is deteriorated due to the blocking.

In this regard, it is to be noted that the first release agent layer 11 may further contain another resin component and/or various additives such as plasticizers, stabilizers, and the like as long as the releasability of the first release agent layer 11 is not deteriorated and the first release agent layer 11 contains no silicone compound and no halogen compound. An amount of each of such another resin component and various additives is lower than 5 mass%.

Furthermore, in the first release sheet 1, an intermediate layer may be provided between the first release agent layer 11 and the first release sheet base 12. By providing such an intermediate layer, it is possible to improve adhesion between the first release agent layer 11 and the first release sheet base 12. In addition to that, it is possible to reliably prevent the peeling from occurring at an interface between the first release agent layer 11 and the first release sheet base 12 when the first release sheet 1 is peeled off from the pressure-sensitive adhesive layer 3. Furthermore, it is possible to reliably prevent a part of the first release agent layer 11 from attaching to or remaining on the pressure-sensitive adhesive layer 3 after the first release sheet 1 is peeled off from the pressure-sensitive adhesive layer 3.

Next, a description will be made on the second release sheet 2 in detail. As shown in FIG. 1, the second release sheet 2 is constituted from the second release sheet base 22 and the second release agent layer 21.

A peeling force of the second release sheet 2 with respect to the pressure-sensitive adhesive layer 3 is larger in a predetermined amount than that of the first release sheet 1 described above with respect to the pressure-sensitive adhesive layer 3.

To be concrete, the peeling force of the second release sheet 2 with respect to the pressure-sensitive adhesive layer 3 is preferably in the range of 60 to 500 mN/20 mm, more preferably in the range of 80 to 300 mN/20 mm. This makes it possible to reliably peel off the second release sheet 2 from the pressure-sensitive adhesive layer 3. In addition to that, when the first release sheet 1 is peeled off from the pressure-sensitive adhesive layer 3, it is possible to efficiently prevent the second release sheet 2 from being involuntarily peeled off from the pressure-sensitive adhesive layer 3 and cohesion failure from occurring.

The second release sheet base 22 has a function of supporting the second release agent layer 21. The same material as the material constituting the first release sheet base 12 described above can be used as a material constituting the second release sheet base 22.

An average thickness of the second release sheet base 22 is not particularly limited, but is preferably in the range of 5 to 300 μm, and more preferably in the range of 10 to 200 μm.

The second release agent layer 21 is constituted of a material containing substantially no silicone compound like the first release agent layer 11 described above. This makes it possible to prevent the transfer of a silicone compound from the second release agent layer 21 to the pressure-sensitive adhesive layer 3 in the double-faced pressure-sensitive adhesive sheet 100. As a result, it is possible to prevent the silicone compound from being released from the pressure-sensitive adhesive layer 3 after the pressure-sensitive adhesive layer 3 is attached to an adherend. Therefore, even when the adherend is the electronic equipments such as a relay, the pressure-sensitive adhesive layer 3 is hard to give adverse effects to such an adherend.

Further, the second release agent layer 21 (and second release sheet base 22) is (are) constituted of a material containing substantially no halogen compound. Therefore, even if a release sheet is disposed of after the use thereof, a harmful halogen compound such as dioxins and the like is not generated during incineration of the release sheet.

To be concrete, the second release agent layer 21 is mainly constituted a diene-based polymer material. Examples of the diene-based polymer material include polybutadiene, polyisoprene, styrene-butadiene, styrene-isoprene, and the like. Among these diene-based polymer materials, polybutadiene (especially, 1,4-polybutadiene) is particularly preferred. This makes it possible to reliably peel off the second release sheet 2 from the pressure-sensitive adhesive layer 3. In addition to that, when the first release sheet 1 is peeled off from the pressure-sensitive adhesive layer 3, it is possible to efficiently prevent the second release sheet 2 from being involuntarily peeled off from the pressure-sensitive adhesive layer 3 and cohesion failure from occurring.

An average thickness of the second release agent layer 21 is not particularly limited, but is preferably in the range of 0.02 to 5.0 μm, more preferably in the range of 0.03 to 3.0 μm, and even more preferably in the range of 0.05 to 1.0 μm. If the average thickness of the second release agent layer 21 is less than the above lower limit value, there is a case where releasability of the second release sheet 2 is poor when the second release sheet 2 is peeled off from the pressure-sensitive adhesive layer 3. On the other hand, if the average thickness of the second release agent layer 21 exceeds the above upper limit value, there is a case where blocking is likely to occur between the second release agent layer 21 and the back surface of the second release sheet 2 (second release sheet base 22) when the second release sheet 2 is wound up in a rolled form so that the releasability of the second release agent layer 21 is deteriorated due to the blocking.

In this regard, it is to be noted that the second release agent layer 21 may further contain another resin component and/or various additives such as plasticizers, stabilizers, and the like as long as the releasability of the second release agent layer 21 is not deteriorated and the second release agent layer 21 contains no silicone compound and no halogen compound. An amount of each of such another resin component and various additives is lower than 5 mass %.

Furthermore, in the second release sheet 2, an intermediate layer may be provided between the second release agent layer 21 and the second release sheet base 22 like the first release sheet 1 described above. By providing such an intermediate layer, it is possible to improve adhesion between the second release agent layer 21 and the second release sheet base 22, and it is possible to reliably prevent the peeling from occurring at an interface between the second release agent layer 21 and the second release sheet base 22 when the second release sheet 2 is peeled off from the pressure-sensitive adhesive layer 3. Furthermore, it is possible to reliably prevent a part of the second release agent layer 21 from attaching to or remaining on the pressure-sensitive adhesive layer 3 after the second release sheet 2 is peeled off from the pressure-sensitive adhesive layer 3.

In the first and second release sheets 1, 2 as described above, when a peeling force of the first release sheet 1 with respect to the pressure-sensitive adhesive layer 3 is defined as “X” [mN/20 mm] and a peeling force of the second release sheet 2 with respect to the pressure-sensitive adhesive layer 3 is defined as “Y” [mN/20 mm], the following relation is satisfied: Y−X≧50. Therefore, when the first release sheet 1 is peeled off from the pressure-sensitive adhesive layer 3, it is possible to reliably prevent the second release sheet 2 from being involuntarily peeled off from the pressure-sensitive adhesive layer 3 and what is called the cohesion failure from occurring.

In this regard, in the first and second release sheets 1 and 2, when the peeling force of the first release sheet 1 with respect to the pressure-sensitive adhesive layer 3 is defined as “X” [mN/20 mm] and the peeling force of the second release sheet 2 with respect to the pressure-sensitive adhesive layer 3 is defined as “Y” [mN/20 mm], the following relation is satisfied: Y−X≧50. However, the relation is preferably satisfied 50≦Y−X≦300, more preferably 50≦Y−X≦200. This makes it possible to conspicuously exhibit the effects according to the present invention as described above.

Next, a description will be made on the pressure-sensitive adhesive layer 3 in detail. In double-faced pressure-sensitive adhesive sheet 100, the first release sheet 1 is attached to the one surface of the pressure-sensitive adhesive layer 3 and the second release sheet 2 is attached to the other surface of the pressure-sensitive adhesive layer 3 as shown in FIG. 1. By peeling off each of release sheets from the pressure-sensitive adhesive layer 3, the pressure-sensitive adhesive layer 3 is capable of attaching to adherends.

The pressure-sensitive adhesive layer 3 is constituted of a pressure-sensitive adhesive composition mainly containing a pressure-sensitive adhesive. Examples of the pressure-sensitive adhesive include an acrylic-based pressure-sensitive adhesive, a polyester-based pressure-sensitive adhesive, and an urethane-based pressure-sensitive adhesive.

For example, in a case where the acrylic-based pressure-sensitive adhesive is used as the pressure-sensitive adhesive, the acrylic pressure-sensitive adhesive can be constituted of a polymer or a copolymer mainly containing a main monomer component for imparting tackiness, a co-monomer component for imparting adhesiveness or cohesive force, and a functional group-containing monomer component for providing crosslinking site or improving adhesiveness.

Examples of the main monomer component include: acrylic alkyl esters such as ethyl acrylate, butyl acrylate, amyl acrylate, 2-ethylhexyl acrylate, octyl acrylate, cyclohexyl acrylate, benzyl acrylate, methoxyethyl acrylate, and the like; and methacrylic alkyl esters such as butyl methacrylate, 2-ethylhexyl methacrylate, cyclohexyl methacrylate, benzyl methacrylate, and the like.

Examples of the co-monomer component include methyl acrylate, methyl methacrylate, ethyl methacrylate, vinyl acetate, styrene, acrylonitrile, and the like.

Examples of the functional group-containing monomer component include: carboxyl group-containing monomers such as acrylic acid, methacrylic acid, maleic acid, and itaconic acid; hydroxyl group-containing monomers such as 2-hydroxyethyl acrylate, hydroxyethyl methacrylate, 2-hydroxypropyl acrylate, 2-hydroxypropyl methacrylate, N-methylolacrylamide, and the like; acrylamide; methacrylamide; glycidyl methacrylate; and the like.

By containing these components, tackiness and cohesive force of the pressure-sensitive adhesive composition are improved. Further, such an acrylic-based resin usually have no unsaturated bond in its molecule, and therefore the pressure-sensitive adhesive composition containing the acrylic pressure-sensitive adhesive has improved stability with respect to light or oxygen. Furthermore, by appropriately selecting the kind of monomer or the molecular weight of the pressure-sensitive adhesive, it is possible to obtain a pressure-sensitive adhesive composition having quality and properties suitable for its purpose of use.

The pressure-sensitive adhesive composition may be either of a crosslinked type to which crosslinking treatment has been carried out or a non-crosslinked type to which crosslinking treatment has not been carried out. However, the crosslinked type is preferably used. By using the crosslinked type pressure-sensitive adhesive composition, it is possible to form the pressure-sensitive adhesive layer 3 having further excellent cohesive force.

Examples of a crosslinking agent to be used for the crosslinked type pressure-sensitive adhesive composition include an epoxy-based compound, an isocyanate compound, a metal chelate compound, a metal alkoxide, a metal salt, an amine compound, a hydrazine compound, an aldehyde compound, and the like.

If necessary, the pressure-sensitive adhesive composition to be used in the present invention may contain various additives such as plasticizers, tackifiers, stabilizers, and the like.

An average thickness of the pressure-sensitive adhesive layer 3 is not particularly limited, but is preferably in the range of 5 to 200 μm, and more preferably in the range of 10 to 100 μm.

In the pressure-sensitive adhesive layer 3 described above, an amount of the gas generated by heating at a temperature of 120° C. for 10 minutes is preferably 1.0 μg/cm² or less in conversion of n-decane. This makes it possible to effectively prevent malfunction of the electronic components from occurring due to the gas generated inside the electronic components such as a hard disk drive and the like when the electronic components become at a high temperature by use thereof.

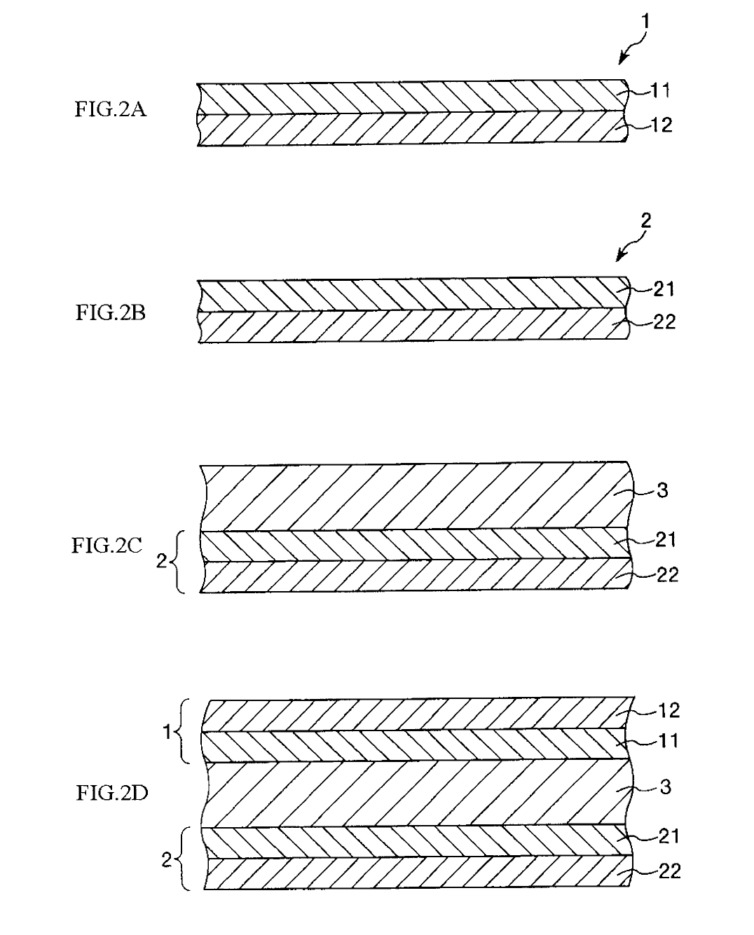

Next, a description will be made on a method of producing the double-faced pressure-sensitive adhesive sheet 100 as described above. FIGS. 2A to 2D are process views showing one example of a method of producing a double-faced pressure-sensitive adhesive sheet used for electronic components according to the present invention. First, the first release sheet base 12 is prepared.

Next, a material for forming the first release agent layer 11, which includes an olefin-based resin as a main component thereof, is applied onto the first release sheet base 12. Thereafter, if necessary, the applied material is subjected to a drying treatment, an ultraviolet irradiating treatment, or the like. As a result, the first release agent layer 11 is formed to obtain the first release sheet 1 as shown in FIG. 2A.

On the other hand, the second release sheet base 22 is prepared. Next, a material for forming the second release agent layer 21, which includes a diene-based polymer material, is applied onto the second release sheet base 22. Thereafter, if necessary, the applied material is subjected to a drying treatment, an ultraviolet irradiating treatment, or the like. As a result, the second release agent layer 21 is formed to obtain the second release sheet 2 as shown in FIG. 2B.

Examples of a method of applying the materials for forming the first and second release agent layers include various conventional methods such as an extrusion coating method, a gravure coating method, a bar coating method, a spray coating method, a spin coating method, a knife coating method, a roll coating method, a die coating method, and the like.

Next, a material for forming the pressure-sensitive adhesive layer 3, which includes a pressure-sensitive adhesive, is applied onto the second release agent layer 21 of the second release sheet 2 to obtain a coating film.

Next, by drying the coating film, the pressure-sensitive adhesive layer 3 is formed on the second release sheet 2 as shown in FIG. 2C.

As described above, first, by forming the pressure-sensitive adhesive layer 3 on the second release sheet 2, it is possible to reliably form the pressure-sensitive adhesive layer 3. In contrast, if the pressure-sensitive adhesive layer 3 is directly formed on the first release sheet 1, the olefin-based resin constituting the first release agent layer 11 is deformed by heat with ease so that there is a case where flatness of the first release agent layer 11 is deteriorated when the coating film is dried. Therefore, there is a case where it becomes difficult to reliably form the pressure-sensitive adhesive layer 3. Furthermore, there is a case where a peeling force between the first release sheet 1 and the pressure-sensitive adhesive layer 3 become rising. As a result, there is a case where it becomes difficult to obtain a sufficient difference between the peeling force of the first release sheet 1 with respect to the pressure-sensitive adhesive layer 3 and the peeling force of the second release sheet 2 with respect to the pressure-sensitive adhesive layer 3.

Examples of a method of applying the material for forming pressure-sensitive adhesive layer 3 onto the second release sheet 2 include various conventional methods such as an extrusion coating method, a gravure coating method, a bar coating method, a spray coating method, a spin coating method, a knife coating method, a roll coating method, a die coating method, and the like.

In this case, the material for forming pressure-sensitive adhesive layer 3 may be of a solvent type, an emulsion type, a hot-melt type, or the like.

As conditions of drying the pressure-sensitive adhesive, a heating temperature is preferably in the range of 100 to 150° C., more preferably in the range of 110 to 130° C. Further, a heating time is not limited, but preferably in the range of 30 seconds to 5 minutes.

Next, the double-faced pressure-sensitive adhesive sheet 100 (double-faced pressure-sensitive adhesive sheet used for the electronic components according to the present invention) is obtained by attaching the first release sheet 1 to the pressure-sensitive adhesive layer 3 which is formed on the second release sheet 2 as shown in FIG. 2D.

According to such a method of producing as described above, it is possible to produce the double-faced pressure-sensitive adhesive sheet 100 without exposing the first release sheet 1, which is relatively weak against heat, in a high temperature condition during the producing thereof.

Although the double-faced pressure-sensitive adhesive sheet used for the electronic components and the method of producing it according to the present invention have been described with reference to the preferred embodiments thereof, the present invention is not limited thereto.

Furthermore, the application of the double-faced pressure-sensitive adhesive sheet used for the electronic components according to the present invention is not limited to electronic components such as relays, various switches, connectors, motors, hard disk drives, and the like as described above.

### Examples

Hereinbelow, actual examples of the double-faced pressure-sensitive adhesive sheet used for the electronic components according to the present invention will be described.

1. Production of Double-faced Pressure-sensitive Adhesive Sheet

### Example 1

[1] Formation of First Release Sheet

First, a polyethylene terephthalate (PET) film (manufactured by TORAY INDUSTRIES, INC. under the trade name of “LUMIRROR-S-28”) was prepared as a first release sheet base. An average thickness of the PET film was 38 μm.

Next, a low-density polyethylene (manufactured by Japan Polyethylene Corporation under the trade name of “NovatecLD LC605Y”, a density thereof is 0.919 g/cm³) was extruding-coated on the prepared first release sheet base so that an average thickness thereof was 15 μm to obtain an intermediate layer.

Next, 60 parts by mass of a low-density polyethylene (manufactured by Japan Polyethylene Corporation under the trade name of “NovatecLD LC800”, a density thereof is 0.916 g/cm³) (polyolefin) was mixed with 40 parts by mass of a copolymer (manufactured by Mitsui Chemicals, Inc. under the trade name of “TafmerP0275G”, a density thereof is 0.856 g/cm³) (polyolefin-based elastomer) of ethylene and propylene to obtain a mixture material as a material for forming a first release agent layer. Then, the mixture material was extruding-coated on the formed intermediate layer so that an average thickness thereof was 10 μm to obtain the first release agent layer. By carrying out processes as described above, a first release sheet was obtained.

[2] Formation of Second Release Sheet

First, a PET film (manufactured by Mitsubishi Polyester Film Inc. under the trade name of “PET50T-100”) was prepared as a second release sheet base. An average thickness of the PET film was 50 μm.

On the other hand, 1,4-polybutadiene (manufactured by ZEON CORPORATION under the trade name of “BR1241”) was diluted by toluene to prepare a material for forming a second release agent layer of which solid content was 1.0 mass %.

Next, the material for forming the second release agent layer was applied onto the second release sheet base by using a meyerbar so that a thickness of the applied material after drying was 0.1 μm. Then, the applied material was dried at a temperature of 100° C. for 1 minute. Thereafter, an ultraviolet ray of 100 mJ/cm² was irradiated to obtain the second release agent layer. By carrying out processes as described above, a second release sheet was obtained.

[3] Formation of Double-Faced Pressure-Sensitive Adhesive Sheet

First, 7 parts by mass of a polyisocyanate compound (manufactured by TOYO INK MFG. CO., LTD. under the trade name of “BHS-8515”) was added as a crosslinking agent with respect to 100 parts by mass of a toluene solution (of which solid content was about 30 mass %) of an acrylic ester copolymer [composition: 2-ethylhexyl acrylate/n-butyl acrylate/2-hydroxyethyl acrylate=60/39/1 (mass %), a mass average molecular mass: about 700,000] to obtain a mixture. This mixture was used as a material for forming a pressure-sensitive adhesive layer.

Next, the material for forming the pressure-sensitive adhesive layer was applied onto the second release sheet by using an applicator so that a thickness of the applied material after drying was 25 μm to obtain a coating film. Then, the obtained coating film was dried at a temperature of 120° C. for 1 minute to obtain a pressure-sensitive adhesive layer.

Next, the first release sheet was attached onto the obtained pressure-sensitive adhesive layer so that the first release agent layer was in contact with the pressure-sensitive adhesive layer. By carrying out processes as described above, the double-faced pressure-sensitive adhesive sheet was obtained.

### Example 2

A double-faced pressure-sensitive adhesive sheet was produced in the same manner as in the Example 1 except that the first release sheet was produced as follows.

First, a PET film (manufactured by TORAY INDUSTRIES, INC. under the trade name of “LUMIRROR-S-28”) was prepared as a first release sheet base. An average thickness of the PET film was 38 μm.

Next, a low-density polyethylene (manufactured by Japan Polyethylene Corporation under the trade name of “NovatecLD LC605Y”, a density thereof is 0.919 g/cm³) was extruding-coated on the prepared first release sheet base so that an average thickness thereof was 15 μm to obtain an intermediate layer.

Next, 50 parts by mass of a low-density polyethylene (manufactured by Japan Polyethylene Corporation under the trade name of “NovatecLD LC800”, a density thereof is 0.916 g/cm³) was mixed with 50 parts by mass of a copolymer of ethylene and propylene (manufactured by Mitsui Chemicals, Inc. under the trade name of “TafmerP0275G”, a density thereof is 0.856 g/cm³) to obtain a mixture material as a material for forming a first release agent layer. Then, the mixture material was extruding-coated on the formed intermediate layer so that an average thickness thereof was 10 μm to obtain the first release agent layer. By carrying out processes as described above, a first release sheet was obtained.

### Example 3

A double-faced pressure-sensitive adhesive sheet was produced in the same manner as in the Example 1 except that a second release sheet was produced as follows and a material for forming a pressure-sensitive adhesive layer was prepared as follows.

[Formation of Second Release Sheet]

First, a PET film (manufactured by Mitsubishi Polyester Film Inc. under the trade name of “PET50T-100”) was prepared as a second release sheet base. An average thickness of the PET film was 50 μm.

On the other hand, polyisoprene (manufactured by KURARAY CO., LTD. under the trade name of “LIR-30”) was diluted by toluene to prepare a material for forming a second release agent layer. A solid content of the material was 1.0 mass %.

Next, the material for forming the second release agent layer was applied onto the second release sheet base by using a meyerbar so that a thickness of the applied material after drying was 0.1 μm. Then, the applied material was dried at a temperature of 100° C. for 1 minute. Thereafter, an ultraviolet ray of 100 mJ/cm² was irradiated to obtain a second release agent layer. By carrying out processes as described above, a second release sheet was obtained.

[Preparation of Material for Forming Pressure-Sensitive Adhesive Layer]

First, 0.1 part by mass of a metal chelate compound (manufactured by Kawasaki Fine Chemicals Co., Ltd. under the trade name of “Aluminum Chelate D”) was added as a crosslinking agent with respect to 100 parts by mass of a toluene solution (solid content: about 30 mass %) of an acrylic ester copolymer (composition: 2-ethylhexyl acrylate/n-butyl acrylate/vinyl acetate/acrylic acid=55/20/23/2 (mass %), mass average molecular mass: about 500,000) to prepare a material for forming a pressure-sensitive adhesive layer.

### Example 4

A double-faced pressure-sensitive adhesive sheet was produced in the same manner as in the Example 1 except that a first release sheet was produced as follows.

First, a PET film (manufactured by TORAY INDUSTRIES, INC. under the trade name of “LUMIRROR-S-28”) was prepared as a first release sheet base. An average thickness of the PET film was 38 μm.

Next, a low-density polyethylene (manufactured by Japan Polyethylene Corporation under the trade name of “NovatecLD LC605Y”, a density thereof is 0.919 g/cm3) was extruding-coated on the prepared first release sheet base so that an average thickness thereof was 15 μm to obtain an intermediate layer.

Next, 70 parts by mass of a low-density polyethylene (manufactured by Japan Polyethylene Corporation under the trade name of “NovatecLD LC800”, a density thereof is 0.916 g/cm3) was mixed with 30 parts by mass of a copolymer of ethylene and propylene (manufactured by Mitsui Chemicals, Inc. under the trade name of “TafmerP0275G”, a density thereof is 0.856 g/cm3) to obtain a mixture material as a material for forming a first release agent layer. Then, the mixture material was extruding-coated on the formed intermediate layer so that an average thickness thereof was 10 μm to obtain the first release agent layer. By carrying out processes as described above, a first release sheet was obtained.

### Comparative Example 1

A double-faced pressure-sensitive adhesive sheet was produced in the same manner as in the Example 1 except that a release sheet (manufactured by Lintec Corporation under the trade name of “PET381031”) was used. Such a release sheet included a release layer which was formed on one surface of a PET film having an average thickness of 38 μm by using a silicone-based release agent as the material for forming the first release agent layer.

### Comparative Example 2

A double-faced pressure-sensitive adhesive sheet was produced in the same manner as in the Example 1 except that a release sheet (manufactured by Lintec Corporation under the trade name of “PET38AL-5”) was used. Such a release sheet included a release layer which was formed on one surface of a PET film having an average thickness of 38 μm by using an alkyd-based release agent as the material for forming the second release agent layer.

### Comparative Example 3

Two second release sheets were produced in the same manner as in the Example 1. Then, a double-faced pressure-sensitive adhesive sheet was produced in the same manner as in the Example 1 by using no first release sheet and the two second release sheets.

### Comparative Example 4

Two first release sheets were produced in the same manner as in the Example 1. Then, a double-faced pressure-sensitive adhesive sheet was produced in the same manner as in the Example 1 by using no second release sheet and the two first release sheets.

In each of the double-faced pressure-sensitive adhesive sheets produced in the Examples 1 to 4 and the Comparative Examples 1 to 4, the constituent material and the ratio of the first release agent layer and the constituent material of the second release agent layer were shown in Table 1. In this regard, it is to be noted that polyolefin was defined as “PO”, the polyolefin-based elastomer was defined as “POE”, 1,4-polybutadiene was defined as “PB”, and polyisoprene was defined as “PI” in Table 1.

TABLE 1

| | | | | | | Pressure-sensitive adhesive layer | | | | |
|---|---|---|---|---|---|---|---|---|---|---|
| | | | | | | Amount of | | | | |
| | First release sheet | | | Second release sheet | | transferred | | | | |
| | First release | | Peeling force | Constituent | Peeling force | silicone compound | | | | |
| | agent layer | | X with respect | material of | Y with respect | [atomic %] | | | | |
| | | Ratio between | to pressure- | second | to pressure- | | Second | Amount of | | |
| | | amount of PO | sensitive | release | sensitive | First | release | generated | | |
| | Constituent | and | adhesive layer | agent | adhesive layer | release | sheet | gasses | Y − X | Releas- |
| | material | amount of POE | [mN/20 mm] | layer | [mN/20 mm] | sheet side | side | [μg/cm²] | [mN/20 mm] | ability |
| Ex. 1 | PO + POE | 6:4 | 80 | PB | 200 | 0.0 | 0.0 | 0.35 | 120 | ◯ |
| Ex. 2 | PO + POE | 5:5 | 65 | PB | 200 | 0.0 | 0.0 | 0.37 | 135 | ◯ |
| Ex. 3 | PO + POE | 6:4 | 70 | PI | 140 | 0.0 | 0.0 | 0.30 | 70 | ◯ |
| Ex. 4 | PO + POE | 7:3 | 95 | PB | 230 | 0.0 | 0.0 | 0.32 | 135 | ◯ |
| Comp. ex. 1 | Silicone- | — | 50 | PB | 200 | 2.0 | 0.0 | 0.38 | 150 | ◯ |
| | based | | | | | | | | | |
| | agent | | | | | | | | | |
| Comp. ex. 2 | PO + POE | 6:4 | 80 | Alkyd- | Not peeling | 0.0 | ND | ND | — | X |
| | | | | based | | | | | | |
| | | | | agent | | | | | | |
| Comp. ex. 3 | PB | — | 200 | PB | 230 | 0.0 | 0.0 | 0.19 | 30 | X |
| Comp. ex. 4 | PO + POE | 6:4 | 80 | PO + | 1010 | 0.0 | 0.0 | 0.35 | 930 | X |
| | | | | POE (6:4) | | | | | | |

2. Evaluation

[Peeling Force Test]

In each of the double-faced pressure-sensitive adhesive sheets obtained in the Examples 1 to 4 and the Comparative Examples 1 to 4, peeling forces of the first and second release sheets were measured.

The peeling force of the first release sheet was measured according to the JIS-Z0237 by cutting the double-faced pressure-sensitive adhesive sheets to have the width of 20 mm and the length of 200 mm, fixing the second release sheet to a tensile tester, and pulling the first release sheet using the tensile tester at a peel rate of 300 mm/min in the 180° direction.

Further, the peeling force of the second release sheet was measured according to the JIS-Z0237 by cutting the double-faced pressure-sensitive adhesive sheet to have the width of 20 mm and the length of 200 mm, attaching the pressure-sensitive adhesive layer from which the first release sheet had been removed to a PET film (manufactured by Mitsubishi Polyester Film Inc. under the trade name of “PET50T-100”), fixing the PET film to a tensile tester, and pulling the second release sheet using the tensile tester at a peel rate of 300 mm/min in the 180° direction.

Further, when the first release sheet was peeled off, it was observed whether or not deformation of the pressure-sensitive adhesive layer, cohesion failure, peeling defect and the like occurred. In a case where they occurred, the peeling property was defined as “×”. In a case where they did not occur, it was further observed whether or not deformation of the pressure-sensitive adhesive layer, cohesion failure, and transferring defect of the pressure-sensitive adhesive layer with respect to an adherend (PET film) occurred when the second release sheet was peeled off. In a case where they did not occur, the peeling property was defined as “◯”. In a case where they occurred, the peeling property was defined as “×”.

[Amount of Transferred Silicone Compound]

In both pressure-sensitive surfaces of the pressure-sensitive adhesive layer of the double-faced pressure-sensitive adhesive sheet from which the first and second release sheets had been peeled off, an amount of Si element (atom) existing on each of the both pressure-sensitive surfaces was measured by using XPS.

[Measurement of Amount of Generated Gases]

The pressure-sensitive adhesive layer from which the first and second release sheets had been peeled off was heated at a temperature of 120° C. for 10 minutes to generate gases. The generated gasses were collected by a purge & trap device (manufactured by Japan Analytical Industry Co., Ltd. under the trade name of “JHS-100A”). Next, the collected gasses were applied into a GC-MS apparatus (manufactured by PerkinElmer Co., Ltd. under the trade name of “Turbo Mass”). Thereafter, an amount of the generated gasses was calculated in conversion of an amount of n-decane. In this regard, the amount converted by n-decane was obtained by an n-decane calibration curve made preliminarily as an detected intensity of the generated gasses obtained by the GC-MS apparatus is a detected intensity of n-decane. These results were shown in Table 1.

As can be seen from Table 1, the double-faced pressure-sensitive adhesive sheets according to the present invention had superior releasability. On the other hand, in the cases of the double-faced pressure-sensitive adhesive sheets of the Comparative Examples 1 to 4, satisfactory results could not be obtained. Further, the double-faced pressure-sensitive adhesive sheets according to the present invention did not contain a silicone compound. This indicated that the double-faced pressure-sensitive adhesive sheets according to the present invention were hard to give adverse effects to the electric components such as relays.

### INDUSTRIAL APPLICABILITY

According to the present invention, it is possible to provide a double-faced pressure-sensitive adhesive sheet used for electronic components which can sufficiently suppress adverse effects on the electronic components and the like and exhibit superior releasability. Further, it is possible to provide a method of producing such a double-faced pressure-sensitive adhesive sheet. Therefore, the present invention has industrial applicability.

What is claimed is:

1. A double-faced pressure-sensitive adhesive sheet used for electronic components, comprising:
a pressure-sensitive adhesive layer;
a first release sheet including at least a first release agent layer attached to one surface of the pressure-sensitive adhesive layer; and
a second release sheet including at least a second release agent layer attached to the other surface of the pressure-sensitive adhesive layer;
wherein the first release agent layer is mainly constituted of an olefin-based resin and the second release agent layer is mainly constituted of a diene-based polymer material,
wherein when an peeling force of the first release sheet with respect to the pressure-sensitive adhesive layer is defined as “X” [mN/20 mm] and an peeling force of the second release sheet with respect to the pressure-sensitive adhesive layer is defined as “Y” [mN/20 mm], the following relation is satisfied: Y−X≧50, and
wherein the pressure-sensitive adhesive layer, the first release agent layer and the second release agent layer contain substantially no silicone compound and substantially no halogen compound.

2. The double-faced pressure-sensitive adhesive sheet used for the electronic components as claimed in claim 1, wherein the olefin-based resin is constituted of polyolefin and polyolefin-based elastomer.

3. The double-faced pressure-sensitive adhesive sheet used for the electronic components as claimed in claim 2, wherein a ratio between an amount of the polyolefin and an amount of the polyolefin-based elastomer is in the range of 9:1 to 5:5 by mass.

4. The double-faced pressure-sensitive adhesive sheet used for the electronic components as claimed in claim 1, wherein when the pressure-sensitive adhesive layer is heated at a temperature of 120° C. for 10 minutes to generate gases, an amount of the generated gases is 1.0 μg/cm² or less in conversion of n-decane.

5. A method of producing the double-faced pressure-sensitive adhesive sheet used for the electronic components defined in claim 1, the method comprising:
applying a material for forming the pressure-sensitive adhesive layer onto the second release agent layer of the second release sheet to form a coating film, the material containing a pressure-sensitive adhesive;
drying the coating film to thereby form the pressure-sensitive adhesive layer; and
attaching the first release agent layer of the first release sheet to the one surface of the formed pressure-sensitive adhesive layer.
